(19) United States
(12) Patent Application Publication
(10) Pub. No.: US 2014/0234512 A1
(43) Pub. Date: Aug. 21, 2014

(54) FOOD PRODUCT PRECURSOR, A FOOD PRODUCT AND A METHOD OF MAKING A FOOD PRODUCT COMPRISING LUPIN FLOUR

(71) Applicant: LUPIN POWER PTY LTD, Canning Vale, WA (AU)

(72) Inventors: Josephus Cronje, Canning Vale (AU); Vijay Jayasena, Bateman (AU)

(73) Assignee: Lupin Power PTY LTD, Canning Vale, WA (AU)

(21) Appl. No.: 14/351,105

(22) PCT Filed: Oct. 23, 2012
(86) PCT No.: PCT/AU2012/001286

§ 371 Date: Apr. 10, 2014

(30) Foreign Application Priority Data
Oct. 27, 2011 (AU) 2011904463

(51) Int. Cl. A23L 1/00; A23L 1/10

(52) U.S. Cl. CPC A23L 1/0076; A23L 1/10
USPC 426/548; 426/622

(57) ABSTRACT

A food product precursor comprising 10-55% by dry-weight lupin flour, other milled grain flour, and 3-10% by wet-weight flavoured liquid. The food product precursor is made into a food product by combining the ingredients to form the food product precursor, cooking the combined food product precursor; and extruding the cooked precursor.

### FIELD OF THE INVENTION

The present invention relates to manufactured food products.

### BACKGROUND TO THE INVENTION

Breakfast cereals are consumed in many countries around the world and competition between the various types of breakfast cereals is strong. Manufacturers of these cereals try to balance taste, texture, dietary fibre, sugar content and salt content in their products. Those cereals that are preferred for taste and texture tend to be low in dietary fibre and protein and high in sugar, fat and/or salt. Those that are high in dietary fibre can be bland or poor in taste and or texture. High fibre breakfast cereals typically still contain high salt and often high sugar.

The inclusion of adequate dietary fibre in the diet is widely promoted for its health benefits. Further, foods that are lower in sugar and salt are also promoted for their health benefits. It is not simply a matter of adding fibre to “tasty” products as this affects the taste and texture of the product. Equally it is not simple to make a high fibre product “tasty” with desirable texture. A solution that achieves this balance has thus far proved to be elusive despite efforts by manufacturers to find a product with the right balance.

As a result current cereals tend to be in one camp or the other, that is, tasty or “healthy”, because these current cereals do not provide a tasty product that is high in dietary fibre, high in protein, low in sugar and salt content, and acceptable in texture.

International Patent Application publication number WO2006/133492 discloses a process for producing a food product made from a dry ingredient mix comprising 1-50% by weight food-grade lupin bran. However this product has not achieved the desired nutritional value of being both high in protein and high in dietary fibre.

An alternative is to use lupin flour from the de-hulled kernel. The fibre in lupin hulls is different to the type of fibre in de-hulled milled lupin kernel (lupin flour).

Typically when lupin flour is used in a food product a less desirable taste and texture can be exhibited in the food product due to bio-active compounds and high protein present in the lupin flour. Thus prior to the present invention food products with lupin flour have not been widely successful.

The present invention was developed with a view to providing a high-fibre, high protein, gluten free food product with acceptable taste and texture, without the need for high salt, sugar or fat content.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided a food product precursor comprising: 10-70% by dry-weight lupin flour, other milled grain flour, and 3-10% by wet-weight flavoured liquid.

In an embodiment the lupin flour is milled from de-hulled lupin.

In an embodiment the other milled grain flour is one or more of buckwheat flour, rice flour, and corn flour.

In an embodiment the food product precursor comprises lupin flour 20-40% by dry-weight. Preferably the lupin flour is about 30% by dry-weight.

In an embodiment the food product precursor comprises buckwheat flour 10-30% by dry-weight. Preferably the buckwheat flour is about 10-20% by dry-weight. In an embodiment the buckwheat flour is about 15% by dry-weight.

In an embodiment the food product precursor comprises rice flour 25-45% by dry-weight. Preferably the rice flour is about 30-40% by dry-weight. In an embodiment the rice flour is about 35% by dry-weight.

In an embodiment the food product precursor comprises corn flour 10-30% by dry-weight. Preferably the corn flour is about 15-25% by dry-weight. In an embodiment the corn flour is about 20% by dry-weight.

In an embodiment the lupin flour, and other milled grain flours are mixed before the liquid is added and mixed.

In an embodiment the food product precursor further comprises a sweetener. In an embodiment the sweetener is about 0.002-40% by weight according to the sweetness of the sweetener. In an embodiment the sweetener is a sugar. In an embodiment the sweetener is an artificial sweetener. In an embodiment the sweetener is sucralose. In an embodiment the food product precursor comprises sweetener 0.01-0.1% by weight. Preferably the sweetener is about 0.03-0.08% by weight. In an embodiment the sweetener is about 0.05% by weight.

In an embodiment the sweetener is mixed with the flours while dry. In an embodiment the sweetener is mixed with the flavoured liquid prior to mixing with the flours.

In an embodiment the food product precursor further comprises a fruit flavoured liquid. In an embodiment the flavoured liquid is or is derived from fruit juice. In an embodiment the flavoured liquid is fruit juice concentrate. In an embodiment the food product precursor comprises flavoured liquid 4-9% by wet-weight. In an embodiment the flavoured liquid is about 6% by wet-weight.

In an embodiment the food product precursor is of a paste-like consistency.

Also according to the present invention there is provided a food product precursor comprising: a mixture of flours in which 10-70% by dry-weight is de-hulled lupin flour, a flavourant and a liquid, wherein the precursor has a moisture content of between 3-10% by wet-weight.

In an embodiment the flavourant comprises a sweetener and/or an end product specific flavour.

In an embodiment the liquid is water or a liquid comprising water.

In an embodiment the liquid comprises a fruit juice or fruit juice concentrate.

According to one aspect of the present invention there is provided a food product formed from the precursor food product defined above.

In an embodiment the food product is formed by cooking and extruding the precursor food product.

In an embodiment the food product comprises protein 15-35% by weight, carbohydrates 40-65% by weight and dietary fibre 5-20% by weight.

In an embodiment the food product is a cooked, extruded food product.

According to one aspect of the present invention there is provided a method of making a food product comprising:

combining ingredients to form a food product precursor, wherein the ingredients comprise 10-70% by weight lupin flour, and one or more of buckwheat flour, rice flour, and corn flour;
adding a flavourant and 3-10% liquid by wet-weight;
cooking the combined food product precursor;
extruding the cooked precursor.

In an embodiment the flavourant comprises a sweetener and/or an end product specific flavour.

In an embodiment the liquid is water or a liquid comprising water.

In an embodiment the liquid comprises a fruit juice or fruit juice concentrate.

In an embodiment the extruding of the cooked precursor is performed by a screw food extruder that forces the wet food precursor through a die under pressure and at temperature so as to cook the food precursor.

In an embodiment the cooking step comprises controlling the temperature to be in the range of 100 degrees C. to 180 degrees C. In an embodiment the cooking temperature increases as the product approaches extrusion. Preferably a substantial portion of the cooking temperature is in the range of 120-160 degrees C. In a preferred embodiment this temperature is between 132 degrees and 139 degrees C. Preferably the cooking step comprises controlling this temperature to be at about 135 degrees C. In an embodiment this temperature is controlled according to the total moisture content and atmospheric humidity.

In an embodiment this cooking temperature is controlled in the middle of the extruder.

In an embodiment the extruding step comprises controlling the extrusion pressure to be in the range of 1 to 20 MPa. Preferably the pressure is in the range of 1.5-5 MPa. Preferably the pressure is in the range of 2-4 MPa. Preferably the pressure is selected according to a desired product expansion upon exit from the die.

In an embodiment the cooked precursor is extruded through a die for forming the food product in a desired shape.

In an embodiment the extrusion temperature is controlled at the die end of an extruder. In a preferred embodiment the temperature at the die end of the extruder is between 150 degrees and 180 degrees, more preferably between 160 degrees and 175 degrees and most preferably between 169 degrees and 172 degrees.

In an embodiment the temperature at the inlet of the extruder is also controlled. In a preferred embodiment the temperature at the inlet is approximately 60 degrees C.

In an embodiment the method further comprises cutting the extruded food to size/shape.

In an embodiment the extruded cooked precursor is dried.

According to one aspect of the present invention there is provided a food product made by the method defined above.

According to one aspect of the present invention there is provided a food product comprising 10-70% by pre-cooked weight lupin flour cooked with one or more of other flours, and 3-10% by pre-cooked weight flavoured liquid, wherein the food product comprises protein 15-35% by weight, carbohydrates 40-65% by weight and dietary fibre 5-20% by weight.

In an embodiment the food product comprises protein of about 20% by weight.

In an embodiment the food product comprises carbohydrates of about 60% by weight.

In an embodiment the food product comprises dietary fibre of about 10% by weight.

In an embodiment the food product comprises energy of 1400-1700 kJ per 100 g. Preferably the food product comprises energy of about 1620 kJ per 100 g.

In an embodiment the food product comprises fats of 3-7% by weight. Preferably the food product comprises fats of about 4.7% by weight.

In an embodiment the food product comprises sugars of 2-5% by weight. Preferably the food product comprises sugars of about 3% by weight.

In an embodiment the food product comprises sodium of 10-30 mg per 100 g. Preferably the food product comprises sodium of about 20 mg per 100 g.

According to one aspect of the present invention there is provided an extruded food product comprising 10-70% by weight lupin flour cooked with one or more of buckwheat flour, rice flour, and corn flour, a flavourant and a sweetener.

In an embodiment the food product comprises cooked lupin flour 20-40% by weight. Preferably the cooked lupin flour is about 30% by weight.

In an embodiment the other flours comprise buckwheat flour 10-30% by weight. Preferably the buckwheat flour is about 10-20% by weight. In an embodiment the buckwheat flour is about 15% by weight.

In an embodiment the other flours comprise rice flour 25-45% by weight. Preferably the rice flour is about 30-40% by weight. In an embodiment the rice flour is about 35% by weight.

In an embodiment the other flours comprise cooked corn flour 10-30% by weight. Preferably the corn flour is about 15-25% by weight. In an embodiment the corn flour is about 20% by weight.

In an embodiment the food product further comprises a dried by cooking flavoured liquid reduction. In an embodiment the flavoured liquid reduction is or is derived from fruit juice. In an embodiment the flavour liquid reduction is fruit flavoured. In an embodiment the flavoured liquid reduction is derived from fruit juice concentrate. In an embodiment the food product comprises a flavoured liquid reduction that was added when wet 3-10% by weight. Preferably the flavoured liquid was added wet by about 4-9% by weight. In an embodiment the flavoured liquid was added wet by about 6% by weight.

In an embodiment the food product further comprises a cooked sweetener. In an embodiment the sweetener is a sugar. In an embodiment the cooked sweetener is sucralose. In an embodiment the food product comprises cooked sweetener 0.01-0.1% by weight. Preferably the cooked sweetener is about 0.03-0.08% by weight. In an embodiment the cooked sweetener is about 0.05% by weight.

In an embodiment the food product is an extruded breakfast cereal.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

In order to provide a better understanding, embodiments of the present invention will be described, by way of example only, with reference to the accompanying drawings, in which:

FIG. 1 is a schematic diagram of a food processor for making the food product according to an embodiment of the present invention; and

FIG. 2 is a flow diagram of an embodiment of the process to produce the food product according to an embodiment of the present invention.

### DETAILED DESCRIPTION OF PREFERRED EMBODIMENTS

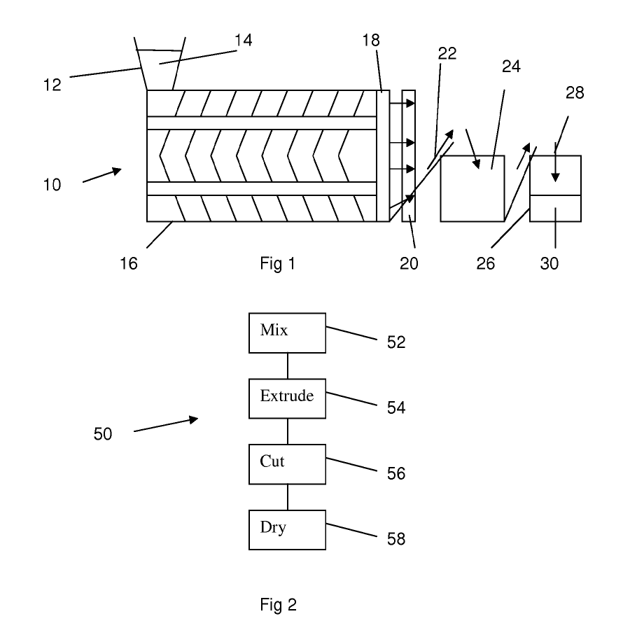

The invention will be described in relation to an embodiment of the method 50 of making the food product shown in FIG. 2. The method employs a food processor 10 is shown in FIG. 1. The food processor 10 comprises a hopper 12, an extruder 16, a die 18, a cutter 20, a drier 24 and a bin 26.

In an embodiment the present invention involves preparing 52 a food product precursor. Such a precursor is prepared by combining in dry form the flours of lupin, and at least one starchy grain, such as rice, buckwheat, and corn. In a preferred embodiment the flours are mixed in proportions as follows, by weight:

| | Range | Preferred range | Most preferred amount |
|---|---|---|---|
| Lupin flour | 10-70% | 20-40% | 30% |
| Buckwheat flour | 10-30% | 10-20% | 15% |
| Rice flour | 25-45% | 30-40% | 35% |
| Corn flour | 10-30% | 15-25% | 20% |

These flours are all commercially available. At this stage the flour mixture is dry, so the weight proportions are dry-weight.

To this mixture is added a flavourant, such as a sweetener and or a flavour essence that introduces the flavour in the end product. For example blueberry flavour essence may be used to introduce a blueberry flavour in the end food product.

The preferred sweetener is sucralose, however other sweeteners can be used, such as sugar (sucrose), corn syrup, dextrose, fructose, stevia, thaumatin or maltose, or other artificial sweeteners such as aspartame, neotame, acesulfame K, or saccharin.

In an embodiment the sucralose is added by weight

| | Range | Preferred range | Most preferred amount |
|---|---|---|---|
| Sucralose | 0.01-0.1% | 0.03-0.08% | 0.05% |

It is desired to have a sweetness of about 20-40% sucrose (or equivalent) by weight and more preferably 30-35%. In the most preferred form, the desired sweetness is about 33% sucrose by weight. Combinations of sweeteners can be used. When determining the sweetness of sweeteners, a sweetness factor of the sweetener compared to sucrose can be used to determine the amount to add. Sweeteners with many times the sweetness of sucrose (herein termed a concentrated sweetener) are desired because they keep the carbohydrate concentration low, while providing a desirable flavour. For example sucralose is about 600 times as sweet as sucrose, so for a 30% sucrose sweetness, 30/600=0.05%, sucralose can be used.

A table of approximate relative sweetness is below along with a percentage by weight to achieve a similar sweetness to a 30% sucrose sweetness.

| Sweetener | Relative sweetness | % required for 30% sucrose equiv. |
|---|---|---|
| Sucrose | 1 | 30% |
| Acesulfame K | 200 | 0.15% |
| Aspartame | 200 | 0.15% |
| Saccharin | 300 | 0.1% |
| Stevia extracts | 300 | 0.1% |
| Sucralose | 600 | 0.05% |
| Thaumatin | 2000 | 0.015% |
| Neotame | 7000-13000 | ~0.003% |

A flavoured liquid is then added to achieve a desired moisture content in the mixture of 3-10% by wet weight, that is the liquid forms the weight proportion of the wet mixture. Preferably the wet mixture has a liquid added in the 4-9% by weight range and more preferably about 6% wet-weight.

The amount of liquid added depends on the atmospheric humidity prevailing as well as the moisture content of the ingredients at the time of manufacture—since liquid added has to be changed to optimise extrusion (obtain desired crispiness and expansion). Too much moisture from the flavoured liquid will make extruded product smaller and harder due to insufficient expansion. Too little moisture will make the product more brittle and negatively affect/reduce the flavour.

In one embodiment the flavoured liquid is water and a flavour essence. In a preferred embodiment the flavoured liquid is or is derived from fruit juice. In an embodiment the flavoured liquid is fruit juice concentrate. The type of fruit can be selected according to a desired flavour of the food product. Thus the fruit juice can act as a flavourant and flavoured liquid, in some cases with an added sweetener, as described above.

In an embodiment the flavoured liquid in the form of fruit juice concentrate is added by weight

| | Range | Preferred range | Most preferred amount |
|---|---|---|---|
| Fruit juice conc. | 3-10% | 4-9% | 6% |

The amount of fruit juice added may be controlled to obtain a desired flavour.

Since a fruit juice will have a sweetener included, for example about 3%, this amount can be added to the sweetness of the added sweetener(s) to come to the total added sweetness.

Further the amount of fruit juice may be controlled in combination with the temperature and pressure to obtain a desired texture in the food product. In particular fine tuning of the fruit juice (or other moisture providing components, such as steam) composition is desired to account for the moisture content in the flours of the dry mix and atmospheric humidity. Typically this is by a feedback process comprising testing the expansion of the extruded food product (as described below) and adjusting the amount of fruit juice (or other moisture source) added.

Mixing the flours, sweetener and liquid flavourant together results in a wet food precursor 14, which is loaded into or mixed in the hopper 12. Typically it is in the form of a paste-like or gelatinized raw mixture. The precursor 14 may be processed into a food product by cooking and extrusion through the extruder 16. Water may be added to the wet food precursor before, during or after the precursor 14 is inserted into the extruder 16. In an embodiment the water may be added as steam. In one embodiment no water is added.

The extruder 16 is preferably a double screw food extruder that forces the wet food precursor 14 through the die 18 under pressure and at temperature so as to cook the food precursor at step 54. The mixture is cooked in the extruder for a suitable time. It is understood that the inclusion of the fruit juice derived flavoured liquid not only has flavour advantages in the final product, but additionally it unexpectedly provides a desirable texture in the final product which it not achieved by use of water alone as a source of moisture in the mixture to be extruded. It is also believed that the fruit juice derived flavoured liquid also provides the unexpected advantage of improved extrusion characteristics.

In an embodiment the cooking step comprises controlling the temperature to be in the range of 100 degrees C. to 180 degrees C. Preferably the temperature is in the range of 120-160 degrees C. In a preferred embodiment the temperature is between 132 degrees and 139 degrees. Preferably the cooking step comprises controlling the temperature to be at about 135 degrees C. In an embodiment the temperature is controlled according to the total moisture content and atmospheric humidity.

In an embodiment the cooking temperature is controlled in a middle portion of the extruder. Typically the cooking mixture will spend the majority of its time in the barrel of the extruder at around this temperature.

In an embodiment the extruding step comprises controlling the extrusion pressure to be in the range of 1 to 20 MPa. Preferably the pressure is in the range of 1.5-5 MPa. Preferably the pressure is in the range of 2-4 MPa. The pressure is generally controlled by controlling the speed of rotation of the extruder screw(s).

In an embodiment the cooked precursor is extruded through a die for forming the food product in a desired shape. The pressure is controlled so as to produce a desired flow rate of extruded product from the die.

Preferably the pressure is selected according to the desired product expansion upon exit from the die. The desired extruded product expansion is approximately 2.5 times the diameter of the die used in the case of a star shaped die. In some embodiments the expansion of the product only occurs at the exit from the die.

In an embodiment the extrusion temperature is controlled at the die end of the extruder. In a preferred embodiment the temperature at the die end of the extruder is between 150 degrees and 180 degrees, more preferably between 160 degrees and 175 degrees and most preferably between 169 degrees and 172 degrees. Thus as the extruded product exits the die it will be at this temperature.

In an embodiment the temperature at the inlet of the extruder is also controlled. In a preferred embodiment the temperature at the inlet is approximately 60 degrees C.

In an embodiment the method further comprises cutting the extruded food to size/shape.

Typically the atmospheric humidity of a room in which the extruder is located is kept constant.

The resulting extruded food is cut 56 to size/shape, such as with a rotary knife, or cutter 20. Other types of food extruder may be used, such as a single screw extruder. The extruded food may be rolled into flat form, such as when the food product is to be in the form of flakes.

In some embodiments the extruded product is coated/dusted with an oil/sugar/flavour and then sent (as indicated by 22) to be dried 58 using a blow dryer 24 or a toaster. In some cases the density/expansion of the food product can be controlled by temperature and time drying. The food product 28 is collected (as shown by 30) in the bin 28 for packaging.

In one embodiment the extruded product dries as it cools, without further intervention.

The lupin flour comprises milled de-hulled lupin grain. In an embodiment the lupin flour may further comprise lupin bran milled to a suitable particle size from seed kernels and or lupin hulls.

A variety of different lupin species may be used in the invention taking into consideration the characteristics of the lupins from which the flour is derived such as the colour of the hulls, ease of hulling, chemical composition and flavour. By way of example, lupins of the following species have been found to be suitable for use in the invention, Lupinus angustifolius, Lupinus albus and Lupinus luteus. Preferably, for the purposes of food safety, lupins for use in the invention should be sourced from growers who can certify the lupins as meeting recognised HACCP (Hazard Analysis Critical Control Point)-based Quality Assured standards.

The resulting food product comprises 10-70% by weight lupin flour cooked with one or more of buckwheat flour, rice flour, and corn flour. In an embodiment the food product comprises cooked lupin flour 20-40% by weight. Preferably the cooked lupin flour is about 30% by weight. In an embodiment the food product comprises cooked buckwheat flour 10-30% by weight. Preferably the cooked buckwheat flour is about 10-20% by weight. In an embodiment the cooked buckwheat flour is about 15% by weight. In an embodiment the food product comprises cooked rice flour 25-45% by weight. Preferably the cooked rice flour is about 30-40% by weight. In an embodiment the cooked rice flour is about 35% by weight. In an embodiment the food product comprises cooked corn flour 10-30% by weight. Preferably the cooked corn flour is about 15-30% by weight. In an embodiment the cooked corn flour is about 20% by weight.

In an embodiment the food product further comprises a dried flavoured liquid reduction. In an embodiment the flavoured liquid reduction is or is derived from fruit juice or fruit juice concentrate. In an embodiment the reduction has its liquid vaporised when the products is extruded, which caused the expansion of the product as it exits the die.

In an embodiment the food product further comprises a sweetener. In an embodiment the food product comprises sweetener as described above

Extruded products containing lupin flour, other flour from other grains, sweetener and fruit flavour, were found to be highly palatable, without the need to add salt and contain significant dietary fibre. Further the food product is gluten-free when in the preferred form. Further still the food product has a significant protein content.

Hence the food product provides an attractive alternative to wheat based high fibre breakfast cereals. Thus it is beneficial as a high-fibre food product suitable for people who are intolerant to gluten.

The food product according to an embodiment of the present invention comprises by weight (per 100 g)

| | Range | Measured amount |
|---|---|---|
| Energy(kJ) | 1400-1700 | 1620 |
| Protein (g) | 15-35 | 20 |
| Carbohydrates (g) | 40-65 | 60 |
| Dietary fibre (g) | 5-20 | 10 |
| Fats (g) | 3-7 | 4.7 |
| Sugars (g) | 2-5 | 3 |
| Sodium (mg) | 10-30 | 20 |

The following nutrition information is publically available on some breakfast cereals, for a measure of 100 g of the respective cereal:

| | Rice | Fruit | | | Corn | Nutri- | |
|---|---|---|---|---|---|---|---|
| | Bubbles | Loops | Crispix | All Bran | Flakes | grain | Special K |
| Energy (KJ) | 1600 | 1640 | 1630 | 1370 | 1580 | 1600 | 1570 |
| Protein (g) | 6 | 6 | 7 | 15 | 7.8 | 21.9 | 19.7 |
| CHO (g) | 87 | 86 | 88 | 45.4 | 82.9 | 69.4 | 70.8 |
| Sugar (g) | 9 | 38 | 24 | 13.6 | 7.9 | 32 | 14.5 |
| Dietary | 1 | 2 | 1 | 29.5 | 3.3 | 2.7 | 2.5 |
| Fibre (g) | | | | | | | |
| Sodium (mg) | 610 | 470 | 725 | 380 | 645 | 560 | 490 |

This nutrition information was obtained in October 2011 from the Kellogg's™ website at the URL: www.kellogg.com.au. These product names are trade marks of Kellogg Company (Delaware, USA).

It can be seen that the food product of the present invention has comparable energy to most of these commercially available products, comparable protein to the high protein products, lower than most in carbohydrates (CHO), the lowest sugar content, higher fibre than most and about a third of the fibre of the high fibre wheat based product and significantly lower salt (measured by sodium).

Further the food product according to an embodiment of the present invention has an enjoyable taste, a satisfying crispiness and a substantial delay in becoming soggy when wet, such as when used as a breakfast cereal with milk. An unexpected advantage is that the food product has a desirable flavour without the need for added salt, particularly as a result of inclusion of the fruit juice derived flavoured liquid in the food product precursor.

The food product may also be suitable to form an extruded snackfood. Other flours may be used such as flours and/or coarse grits of wheat, barley, tapioca, potato, triticale, etc, or starch extracts of these.

Other flavourants, such as commercial savoury mixes typically used in the production of snackfood products, may be added prior to extrusion processing. Alternatively, such flavourants may be withheld from the dry ingredient mix and added post-extrusion as flavourant addition.

Lupin flour generally comprises about 40% protein and 30% dietary fibre, along with other nutritionally beneficial compounds. However lupin flour also contains a range of chemical compounds with an undesirable taste (such as phenolic compounds. The present invention produces a food product that is able to mask the undesirable taste originating from the use of lupin flour, while at the same time still benefiting from the nutritional benefits of using lupin flour. Further the present invention is able to produce a texturally desirable product in that it has a suitable crunchiness typically desired in a breakfast cereal.

It will be readily apparent to persons skilled in the relevant arts that various modifications and improvements may be made to the foregoing embodiments, in addition to those already described, without departing from the basic inventive concepts of the present invention. The described examples are given for illustrative purposes only and therefore it will be appreciated that the scope of the invention is not limited to the specific embodiments described.

1. An extruded food product precursor, that is ready for extrusion, comprising 10-55% by dry-weight lupin flour, other milled grain flour, and 3-10% by wet-weight liquid, wherein the food product precursor is suitable for extrusion so as to form an expanded, extruded food product, and wherein the majority of protein in the food product precursor is in the flours.

2. A food product precursor according to claim 1, wherein the food product precursor comprises lupin flour 20-40% by dry-weight.

3. A food product precursor according to claim 1, wherein the other milled grain flour is at least 55% of the dry weight of the food product precursor.

4. A food product precursor according to claim 1, wherein the other milled flour comprises one or more of buckwheat flour, rice flour, and corn flour.

5. A food product precursor according to claim 4, wherein the food product precursor comprises buckwheat flour 10-30% by dry-weight.

6. A food product precursor according to claim 4, wherein the food product precursor comprises rice flour 25-45% by dry-weight.

7. A food product precursor according to claim 4, wherein the food product precursor comprises corn flour 10-30% by dry-weight.

8. A food product precursor according to claim 1, wherein the food product precursor has a dietary fibre content of about 5-20% by weight.

9. A food product precursor according to claim 8, wherein the majority of dietary fibre content in the food product precursor is in the flours.

10. A food product precursor according to claim 1, wherein the food product precursor further comprises a sweetener having at least 200 times the sweetness of sucrose

11. A food product precursor according to claim 10, wherein the sweetener comprises sucralose.

12. A food product precursor according to claim 10, wherein the food product precursor comprises sweetener in the amount of 0.01-0.1% by weight.

13. A food product precursor according to claim 1, wherein the liquid comprises a fruit flavoured liquid.

14. A food product precursor according to claim 13, wherein the flavoured liquid comprises a fruit juice concentrate.

15. A food product precursor according to claim 13, wherein the flavoured liquid is 4-10% by wet-weight.

16. A food product precursor according to claim 1, wherein the food product precursor comprises fats of 3-7% by weight.

17. An extruded food product precursor, that is ready for extrusion, comprising: a mixture of flours in which 10-55% by dry-weight is de-hulled lupin flour, a sweetener and a fruit juice concentrate, wherein the precursor has a moisture content of between 3-10% by weight and is suitable for extrusion so as to form the expanded, extruded food product, wherein the food product precursor comprises fats of 3-7% by weight.

18. A food product precursor according to claim 17, wherein the majority of protein in the food product precursor is in the flours.

19. A food product precursor according to claim 17, wherein the food product precursor has a dietary fibre content of about 5-20% by weight.

20. A food product precursor according to claim 19, wherein the majority of dietary fibre in the food product precursor is in the flours.

21. A food product precursor according to claim 17, wherein the sweetener is about 0.002-0.2% by weight.

22. A food product formed from the precursor food product defined in claim 1, wherein the food product is formed by cooking and extruding the precursor food product and the food product expands following extrusion.

23. A food product according to claim 22, wherein the food product comprises protein 15-35% by weight, carbohydrates 40-65% by weight and dietary fibre 5-20% by weight.

24. A method of making a food product comprising:
combining ingredients to form a food product precursor, wherein the ingredients comprise 10-55% by dry-weight lupin flour, one or more of buckwheat flour, rice flour, and corn flour, wherein the majority of protein in the combined ingredients is in the flours,
adding 3-10% liquid by wet-weight;
cooking the combined food product precursor;
extruding the cooked precursor so as to form an expanded, extruded food product.

25. A method according to claim 24, wherein the liquid comprises a flavourant which comprises a sweetener and a juice flavoured liquid.

26-31. (canceled)

32. A food product made by the method defined in claim 23.

33. An expanded, extruded food product comprising 10-55% by weight lupin flour cooked with one or more of buckwheat flour, rice flour and corn flour, and 3-10% by weight flavoured liquid; and wherein the food product comprises: protein 15-35% by weight, carbohydrates 40-65% by weight and dietary fibre 5-20% by weight, wherein the majority of protein in the food product precursor is in the flours; wherein the food product has been formed by extrusion and the food product expanded following extrusion.
